(19) United States
(12) Patent Application Publication
(10) Pub. No.: US 2009/0302667 A1
(43) Pub. Date: Dec. 10, 2009

(54) SYSTEM AND METHOD FOR PROTECTING A LEG OF A PASSENGER IN A COMMON CARRIER

(76) Inventor: Domenico Basile, Daverio (IT)

Correspondence Address: Cislo & Thomas LLP, 1333 2nd Street, Suite #500, Santa Monica, CA, 90401-4110, US

(21) Appl. No.: 12/211,798

(22) Filed: Sep. 16, 2008

Related U.S. Application Data
(60) Provisional application No. 61/129,135, filed on Jun. 6, 2008.

(51) Int. Cl. B60R 21/00

(52) U.S. Cl. 297/466

(57) ABSTRACT

A system and method for reducing injuries within an aisle entry using a leg arresting device. The leg arresting device includes a leg engaging surface, an arm coupled to the leg engaging surface, and an end member coupled to the arm and connected to an attachment point in front of the user. The end member can be coupled to many locations, including a wall or seat, in front of the user. To prevent injuries, the user simply sets up the leg arresting device by positioning the end member against an attachment point in front of the user. In turn, the user adjusts at least one of the leg engaging surface, arm, and end member of the leg arresting device so that the leg engaging surface is comfortably placed against the user's knee or leg. The leg arresting device can also be used for resting a user's legs or thighs.

### CROSS-REFERENCE TO RELATED APPLICATIONS

This patent application claims the benefit of U.S. Provisional Application Ser. No. 61/129,135 to Domenico Basile entitled “LEG SUPPORT AND PROTECTION DEVICE” filed Jun. 6, 2008, which is incorporated herein by reference.

### TECHNICAL FIELD

This application generally relates to leg injuries, and, more particularly, to protecting passengers from leg injuries in a common carrier by placing a leg arresting device between a user's leg and an aisle.

### BACKGROUND

Throughout our waterways, airways, and railways, thousands of injuries occur each year. These injuries are a result of mass transportation vehicles that carry numerous amounts of people. These vehicles can include buses, trains, planes, ships, etc. Each of these mass transportation vehicles generally sit people in rows with aisles partitioning one side of passengers from another side of passengers. While these aisles have beneficial effects, such as providing space for carts to service passengers, these aisles can become quite dangerous.

An injury can result when a passenger places their leg into the aisle. When an inattentive person walks by, the person can trip over the passenger's leg causing the inattentive person to trip. Furthermore, the passenger's leg can be injured when a trolley or cart servicing the passengers of the vehicle hits the passenger's leg.

### SUMMARY

This summary is provided to introduce a selection of concepts in a simplified form that are further described below in the DETAILED DESCRIPTION OF THE APPLICATION. This summary is not intended to identify key features of the claimed subject matter, nor is it intended to be used as an aid in determining the scope of the claimed subject matter.

In accordance with one embodiment of the present application, a method for preventing injuries in a common aisle of a common carrier is presented. The method includes positioning a leg arresting device besides a user's knee or leg, the leg arresting device having a leg engaging surface, an arm coupled to the leg engaging surface, and an end member coupled to the arm. In addition, the method includes adjusting at least one of the leg engaging surface, arm, and end member of the leg arresting device so that the leg engaging surface comfortably braces the user's knee or leg. The method includes blocking with the leg engaging surface the user's knee or leg from entering the common aisle when the user's knee or leg moves laterally enough to engage the leg engaging surface.

In accordance with another embodiment of the present application, a method for restraining a user's knee or leg from entering into an aisle of a plane, train, or other common carrier using a leg arresting device is presented. The leg arresting device includes a leg engaging surface, an arm coupled to the leg engaging surface, and an end member coupled to the arm. The method includes positioning the leg arresting device on an aisle entry. In addition, the method includes manipulating at least one of the leg engaging surface, arm, and end member of the leg arresting device to prevent lateral movement of the user's knee or leg into the aisle.

In accordance with yet another embodiment of the present application, a system for providing protection to passengers of a common carrier is presented. The system includes at least one or more seats and an attachment point positioned in front of the at least one or more seats. In addition, the system includes a leg arresting device coupled to the attachment point in front of the at least one or more seats, the leg arresting device having a leg engaging surface, an arm coupled to the leg engaging surface, and an end member coupled to the arm.

### BRIEF DESCRIPTION OF DRAWINGS

The novel features believed characteristic of the application are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a diagram showing an illustrative pair of seats each having an exemplary leg arresting device that prevents a user's leg from entering into an aisle in accordance with one aspect of the present application;

FIG. 2 is an illustration showing an exemplary leg arresting device rotating along a vertical axis in accordance with one aspect of the present application;

FIG. 3 is a diagram showing a seat having an exemplary leg arresting device connected to its armrest in accordance with one aspect of the present application;

FIG. 4A is a diagram showing an exemplary attachment to the leg arresting device in accordance with one aspect of the present application;

FIG. 4B is a diagram showing an alternative exemplary attachment coupled to the leg arresting device in accordance with one aspect of the present application;

FIG. 5A is a diagram showing a side view of an illustrative leg arresting device with a foldable leg engaging surface in accordance with one aspect of the present application;

FIG. 5B is a diagram showing a side view of an illustrative leg arresting device with a rotating leg engaging surface in accordance with one aspect of the present application;

FIG. 6A is a diagram showing a top view of an illustrative leg arresting device in accordance with one aspect of the present application;

FIG. 6B is a diagram showing a top view of an illustrative leg arresting device with an anatomically curved leg engaging surface in accordance with one aspect of the present application;

FIG. 7A is a diagram showing an illustrative leg arresting device having a U-shaped end in accordance with one aspect of the present application;

FIG. 7B is a diagram showing a top view of an exemplary foldable leg arresting device having a U-shaped end in accordance with one aspect of the present application; and

FIG. 7C is a diagram showing a top view of an exemplary foldable leg arresting device having a U-shaped end in accordance with one aspect of the present application.

### DETAILED DESCRIPTION OF THE APPLICATION

The detailed description set forth below in connection with the appended drawings is intended as a description of presently-preferred embodiments of the invention and is not intended to represent the only forms in which the present application may be constructed and/or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

Generally described, the present application relates to a system and method for reducing injuries. In particular, the present application relates to a leg arresting device that prevents a user's leg from entering into an aisle and specifically, an aisle entry. In an illustrative embodiment, the leg arresting device includes a leg engaging surface, an arm coupled to the leg engaging surface, and an end member coupled to the arm and connected to an attachment point in front of the user. To prevent injuries, the user simply sets up the device by bracing the end member against an attachment point in front of the user. The user can then adjust the leg engaging surface, arm, or end member so that the leg engaging surface is comfortably placed against the user's leg.

While the term leg arresting device is used throughout this application, the term is not to be construed as limiting to the scope of this invention as recited in this application. One skilled in the relevant art will appreciate that the term leg arresting device may be replaced by a number of different terms that prevents a user's leg from entering into an aisle. Such terms may include, but are not limited to, partition, barrier, fence, wall, blockade, barricade, obstruction, or obstacle.

As one skilled in the relevant art would appreciate, the leg arresting device If can be used in a variety of settings. In one setting, the leg arresting device can be placed on an airplane. During long flights, passengers often fall asleep. Throughout this period, the user's leg may drift into an aisle causing injury to the user themselves or someone else. In addition, the leg arresting device can be used in buses, trains, ships, churches, synagogues, meeting halls, legislatures, courtrooms, theaters, etc. Because the leg arresting device may be used in a wide variety of areas, passenger, user, etc. can be interchanged without limiting the scope of the invention as disclosed in this application.

The leg arresting device generally prevents a lower portion of a user's body from entering into an aisle. In particular, the leg arresting device restrains the lateral movement of the user's leg into an aisle. The leg arresting device typically matches the height of the lower part of the user's femur and the upper portion of the tibia, which corresponds to the knee area.

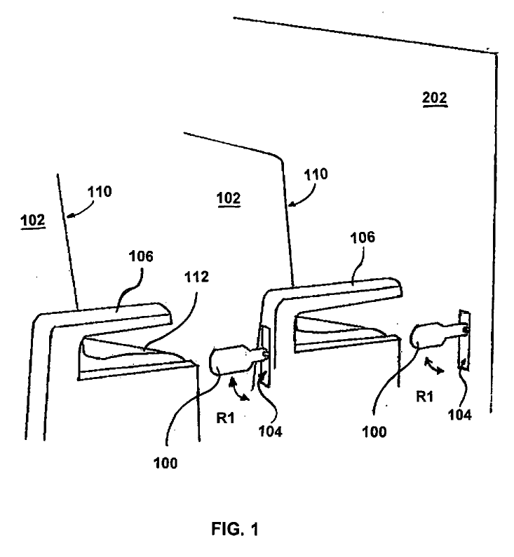

With reference now to FIG. 1, an illustrative pair of seats 102 each having an exemplary leg arresting device 100 that prevents a user's leg from entering into an aisle in accordance with one aspect of the present application is presented. Each leg arresting device 100 prohibits a user's leg from entering into an aisle. More specifically, the leg arresting device 100 prevents a user's leg from passing the aisle entry located at the end of each row of seats 102. Each row may include multiple seats 102. As shown, the leg arresting device 100 is typically connected to an attachment point in front of the user. In this embodiment, the attachment point is a seat 102. The attachment point can be any location in front of the user. Alternatively, the attachment point may be located on the side or behind the user.

Each seat 102 can include an armrest 106, a main body 110, a slot between the armrest 106 and main body 110, and padding 112 to rest on top of the seat 102 for user comfort. The seat 102 can also include a compartment 104 for storing the leg arresting device 100, which is generally located in front of the user. In one embodiment, the compartment 104 will be located internally within the seat 102 or armrest 106.

The compartment 104 can be an elongated vertical slot having the shape of the leg engaging surface. Furthermore, the compartment 104 can be an elongated indentation conformed to the shape of the leg engaging surface. The compartment 104 or indentation may include additional room for other items such as purses, wallets, backpacks, etc. Also, the elongated vertical slot can include a cover for completely concealing the compartment 104 and the leg arresting device 100.

In another embodiment of the present application, the compartment 104 penetrates deep into the armrest 106 of the seat 102. The compartment 104 housing the leg arresting device 100 is not always an elongated vertical slot, but may come in a variety of different shapes, sizes, and forms.

The leg arresting device 100 can be connected to the compartment 104 through a set of fastening devices. These fastening devices may include hinges, bolts, and screws. Alternatively, the leg arresting device 100 can be coupled to the compartment 104 through a number of hook and loop fasteners or collapsible structures that allow the user to push the leg arresting device 100 into the seat 102.

With continued reference to FIG. 1, the diagram shows exemplary seats 102 having leg arresting devices 100 deployed 102 in accordance with one aspect of the present application. In this embodiment, the leg arresting device 100 swings from the compartment 104 located in the armrest 106 of the seat 102 along line R1 from a lower position to a higher position. Alternatively, the leg arresting device 100 can swing downwards from a top position to a lower position. Each leg arresting device 100, as shown in the FIGURE, is intended for the user behind the seat 102 having the leg arresting device 100. In typical embodiments, a mechanism for releasing and binding the leg arresting device 100 can be used so that with a simple press of the mechanism, the leg arresting device 100 will traverse back and forth along line R1 automatically.

While the leg arresting device 100 typically can extend into an upright position, the user can adjust the angle and height of the leg arresting device 100 through a fastening mechanism. A bolt, hinge, or the like can be tightened to prevent the leg arresting device 100 from swinging to its full height. This allows a user to adjust the leg arresting device 100 in order to provide individual user comfort. As such, different individuals having varying knee heights can use the leg arresting device 100.

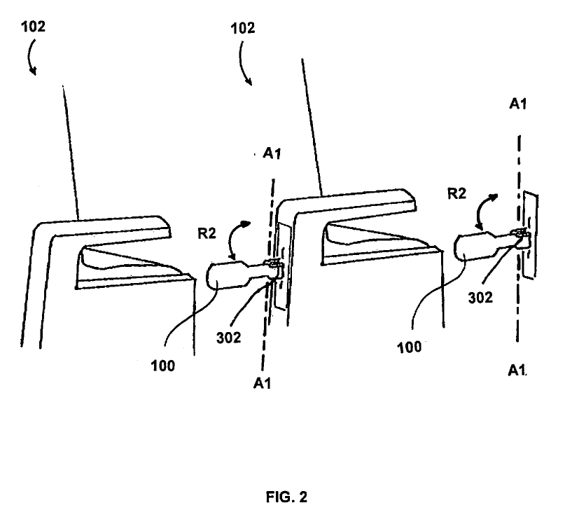

FIG. 2 is an illustration showing an exemplary leg arresting device 100 extending from a compartment 104 located in a wall 202 in front of the user in accordance with one aspect of the present application. The leg arresting device 100 can be placed into a variety of different locations and connected through a swing mechanism 302. Furthermore, in some embodiments of the present application the leg arresting 100 does not require a compartment 104, but instead can be set up using other methods.

As shown in the previous FIGURES, a user on the aisle can have a leg arresting device 100 in front of them and in back of them. In other embodiments, a seat 102 can also include leg arresting devices 100 for separating seats 102 within a row. This prevents a user's lower body portion from entering into the space of another.

In another embodiment of the present application, a seat 102 can include leg arresting devices 100 that separate passengers' top portions. This prevents a user's upper body from entering into the aisle or into the space of another. In this embodiment, the leg arresting devices 100 can be placed into the main body 110 of the seat 102 in front of the user.

Continuing with FIG. 2, the diagram shows the leg arresting device 100 being deployed from the wall 202 within the common carrier. Unlike FIG. 1, however, the leg arresting device 100 is capable of rotating or swinging left to right along line R2 and around axis A1 through swing mechanism 302. Line R2 ends at the back of the seat 102. To prevent injuries, preferred embodiments preclude the leg arresting device 100 from swinging into the aisle. When not in use, the user simply swings the leg arresting device 100 against the wall 202 or seat 102 in front of them.

This prevents other parties from tripping over the leg arresting device 100. While the leg arresting devices 100 of FIGS. 1 and 2 provide for an up and down or left and right motion, the leg arresting device may also rotate in multiple directions using a pivot head.

Generally, the height of the leg arresting devices 100 match the height of the lower part of the femur and the upper portion of the tibia of the user to prevent the leg from entering into the aisle. This corresponds with the height of the user's general knee area.

The leg arresting devices 100 can be easily setup and stored during emergencies. In most cases, the use of the leg arresting device 100 will be subject to current laws and regulations. For example, airlines using the leg arresting device 100 must typically comply with safety regulations dictated by the Civil Aviation Authority (FAA or JAA).

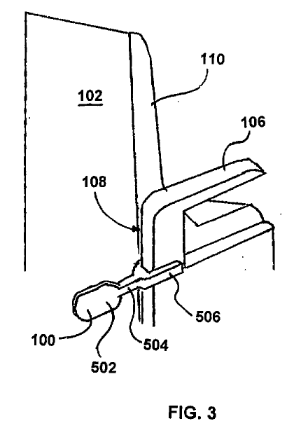

With reference to FIG. 3, a diagram showing a seat 102 having an exemplary leg arresting device 100 connected to an armrest 106 in accordance with one aspect of the present application is presented. In this embodiment, the end member 506 has a “U” shaped end. The U-shaped end 506 will embrace the back of the armrest 106 of the passenger seat 102 in front of the user. The leg arresting device 100 can be removable and stored into a separate area or compartment.

In another embodiment of the present application, the slot 108 between the armrest 106 and main body 110 can retain the leg arresting device 100. In this embodiment, the leg arresting device 100 includes a flat end member 506 that can be inserted into the slot 108. The end member 506 of the leg arresting device 100 can have a flat surface able to insinuate itself between the back of the armrest 106 and the back of the main body 110 of the seat 102.

In an alternative embodiment of the present application, the leg arresting device 100 does not include a U-shaped end member 506. Instead, the leg arresting device 100 can use an adhesive or some other type of apparatus that connects the leg arresting device 100 to the armrest 106 or wall 202 in front of the user. While a number of embodiments of the leg arresting device 100 have been described, the leg arresting device 100 may be connected to an attachment point in front of the user through a variety of different ways.

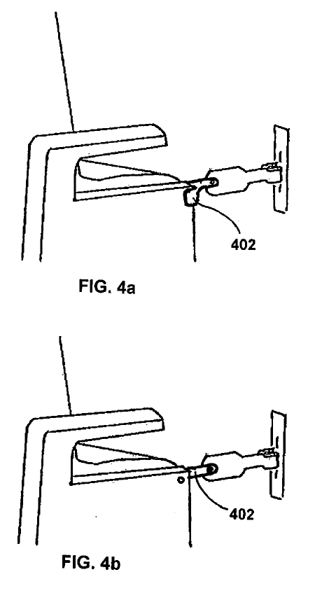

FIG. 4A is an illustration showing an exemplary attachment 402 for coupling a leg arresting device 100 to a user's seat 102 in accordance with one aspect of the present application. Through this attachment 402, the user can position the leg arresting device 100 at an angle. Furthermore, the attachment 402 can prevent items from entering into an aisle. Also, the attachment 402 can prohibit the leg arresting device 100 from moving in an up, down, left, and right motion. In an alternate embodiment, the attachment 402 can easily break or release allowing for free passage and quick evacuation of the common carrier.

Typically, the attachment 402 may be made of an elastic material such as rubber including hard or soft rubber. The attachment 402 can also be made of several different types of materials. Furthermore, the attachment 402 may be molded onto the leg arresting device 100 or can be an add-on.

The attachment 402, as depicted in FIG. 4A, incorporates a pair of fingers that wrap around the armrest 106 of the seat 102. The fingers can include a material having a high coefficient of friction to prevent slippage.

In a preferred embodiment, springs or other shock absorbing mechanisms can be placed on the leg arresting device 100 in order to reduce vibrations. Because the leg arresting device 100 is generally attached to a point in front of the user, the spring or shock mechanisms will reduce disturbances to a person in front of the user.

FIG. 4B is a diagram showing an alternative exemplary attachment 402 coupled to the leg arresting device 100 in accordance with one aspect of the present application. The attachment 402 can be secured into place through screw members or the like. Alternatively, the attachment 402 can be lowered into the armrest 106 of the user's seat 102 or other area that provides for a stable attachment point.

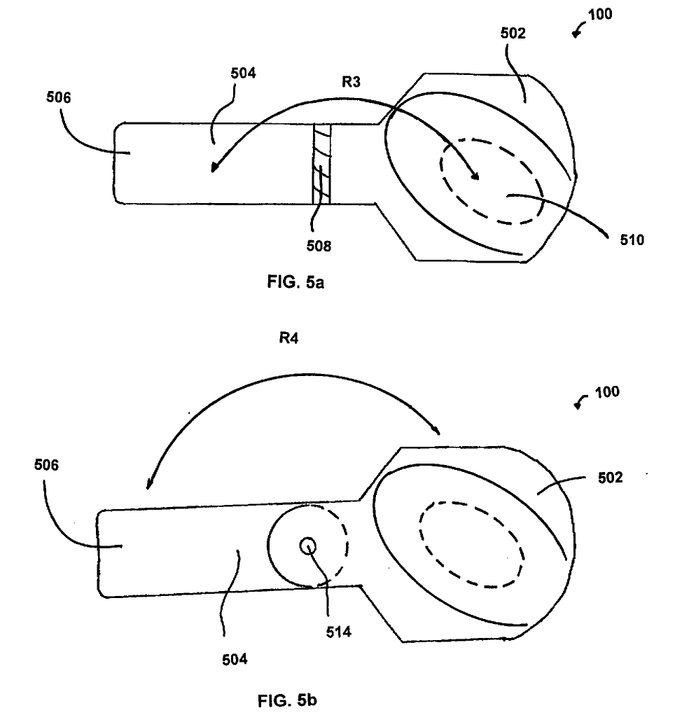

FIG. 5A is a diagram showing a side view of an illustrative leg arresting device 100 with a foldable leg engaging surface 502 in accordance with one aspect of the present application. The leg arresting device 100 typically includes a leg engaging surface 502, an arm coupled to the leg engaging surface 504, and an end member 506.

The leg engaging surface 502 can include a flat or anatomically slightly curved or contoured surface. The surface 502 is shaped to accommodate and provide adequate leg engaging and protection to a human knee or leg resting on the surface 502 of the leg arresting device 100. Generally, the leg engaging surface 502 includes a vertical area wide enough to cover a human knee from the lower part of the femur to the upper part of the tibia. Nonetheless, the leg engaging surface 502 may come in a variety of different sizes, shapes, and forms.

The leg engaging surface 502 works by bracing the user's lower part of the femur and the upper part of the tibia. In addition, the leg engaging surface prevents lateral movement of the user's leg into an aisle. The leg engaging surface 502 also provides protection to the passenger's knee area against the possibility of impact with an object or a person moving in the aisle.

Padding 510 is normally included with the leg engaging surface 502. The user can rest or lean the weight of their legs on or against the padding 510 of the leg arresting device 100 without causing any discomfort or bruising. Alternatively, the user can rest or lean the weight of their legs on or against the leg arresting device 100 without padding 510. As a result, the user can relax their leg or muscles against the padding 510 and go to sleep without being mindful that his or her leg will inadvertently venture out into the commonly trafficked area while the user is asleep, thereby greatly improving the options for the traveler. On the other side of the leg engaging surface 502, a scratch resistant material can be used.

Coupled to the leg engaging surface 502 is the arm 504 of the leg arresting device 100. The arm 504 can be adjusted so that the leg engaging surface 502 can be positioned at the user's knee area. In one embodiment, the arm 504 can be made of flexible or bendable materials. Alternatively, the arm 504 can be made of rigid materials and thus, does not allow the arm 504 to bend. The arm 504 can include extensions and can be foldable or non-foldable.

Also coupled to the arm 504 and on an opposite end of the leg engaging surface 502 is the end member 506. The end member 506 can be coupled to a wall 202, seat 102, or some other attachment point. Preferably, the attachment point should be sturdy and capable of supporting the leg arresting device 100 and the user's leg.

As shown in the previous FIGURES, the leg arresting device 100 is coupled to an attachment point through a fastening mechanism. The fastening mechanism can be a bolt, screw, nail, rivet, roll pin, or pinned shaft. Alternatively, the leg arresting device 100 can be permanently coupled by welding, soldering, brazing, or gluing the leg arresting device 100 to the attachment point, which can still be easily broken in the event of an emergency. Still yet, the leg arresting device 100 can be coupled through hook and loop fasteners, which can facilitate quick release in the event quick exit is desired.

In order to support the weight of the user, the leg arresting device 100 can typically be made of plastic, composite, wood, light metal, or an alloy. While each section of the leg arresting device 100 can be made of similar materials, it is preferred that each section be made of different materials. For example, the arm 504 portion can be made of a more flexible material than the leg engaging surface 502 or the end member 506. This would allow a user to adjust the arm 502 to match the height of the user's knee while keeping the leg engaging surface 502 and end member 506 rigid.

As shown in FIG. 5A, the leg arresting device 100 includes a foldable leg engaging surface 502. Included on the leg arresting device 100 is a foldable joint 508. The foldable joint 508 allows the foldable leg engaging surface 502 to pivot along line R3. In another embodiment of the present application, the foldable joint 508 can be located near or on the end member 506 of the leg arresting device 100. The foldable joint 508 can be place on any location on the leg arresting device 100 and swung from that point.

The foldable joint 508 can be made of at least one or more hinges. Alternatively, the foldable joint 508 can be made of cloth. The foldable joint 508 can be made of many different materials and can include, but not limited to, metal, plastic, wood, etc.

By using the foldable joint 508, the overall length of the leg arresting device 100 can be reduced. While FIG. 5A shows only a single foldable joint 508, the leg arresting device 100 may include a plurality of foldable joints 508. Through these foldable joints 508, the leg arresting device 109 may be folded horizontally, vertically, or both. Although the leg arresting device 100 illustrated by FIG. 5A includes a foldable joint 508, the leg arresting device 100 can be non-foldable and contain no foldable joints 508.

While the previous discussion discloses three main components for the leg arresting device 100, one skilled in the relevant art will appreciate that the leg arresting device 100 is not limited to a leg engaging surface 502, an arm 504 coupled to the leg engaging surface 502, and an end member 506 coupled to the arm 504 and connected to an attachment point.

FIG. 5B is a diagram showing a side view of an illustrative leg arresting device 100 with a rotating leg engaging surface 502 in accordance with one aspect of the present application. In this embodiment, the leg arresting device 100 includes a ring or pivoting hinge 514 coupled to the arm 504 and the leg engaging surface 502. The ring 514 allows for the leg engaging surface 502 to move along line R4 thereby collapsing the leg arresting device 100. This reduces the overall size of the leg arresting device 100 and allows it to be stored in a compartment 104 or another way.

The ring or pivoting hinge 514 can be positioned at different locations. In one embodiment, the ring 514 is positioned near or at the end member 506.

Typically, the leg engaging surface 502 can be positioned at different angles. Once the leg engaging surface 502 is positioned at the appropriate angle, the leg engaging surface 502 can be secured by a fastening device. The fastening device can include a hook and loop fastener. Alternatively, the fastening device can include any other type of mechanical latch.

The leg engaging surface 502 can also be adjusted using a rectangular shaped joint which allows the leg engaging surface 502 and the arm 504 segments to slide over one another to reach a desired extension length. Typically, the leg arresting device 100 includes a fastening device as described above to secure the two segments together.

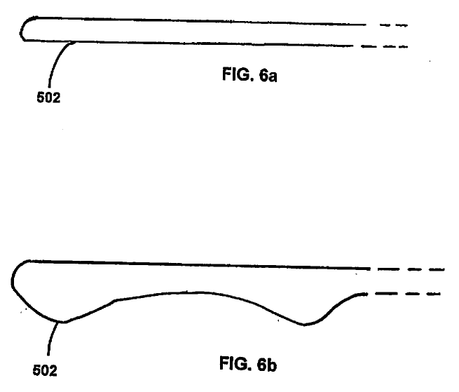

With reference to FIG. 6A, a diagram showing a top view of an illustrative leg arresting device 100 in accordance with one aspect of the present application is presented. The top of the leg arresting device 100 can include reflectors or paint to draw attention to the leg arresting device 100 when it is being used. In other embodiments, the entire leg arresting device 100 can be made of a reflective material.

FIG. 6B is a diagram showing a top view of an illustrative leg arresting device 100 with an exemplary anatomically curved or contoured leg engaging surface 502 in accordance with one aspect of the present application. The leg engaging surface 502 can be made of many types of materials depending on the user.

While the leg engaging surface 502 is typically permanently affixed to the arm 504, alternative implementations of the leg arresting device 100 incorporate removable leg engaging surfaces 502. In such implementations, a user can carry along their own leg engaging surface 502 and simply attach them to the arm 504 of the leg arresting device 100.

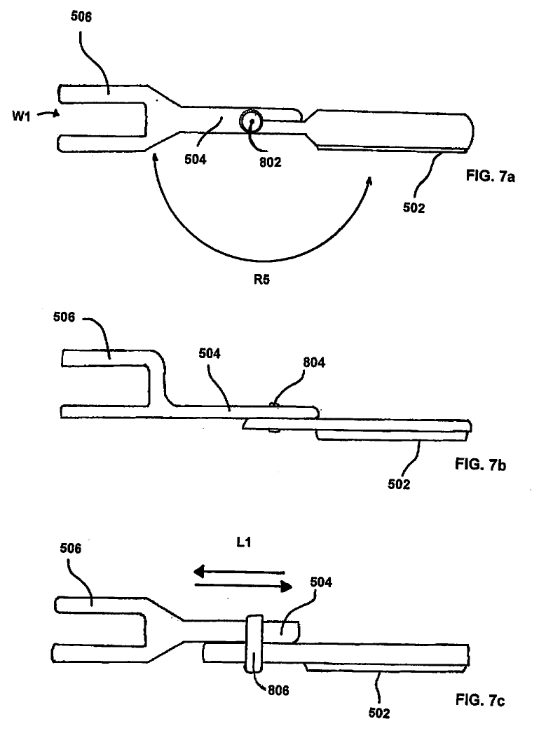

FIG. 7A is a diagram showing an illustrative leg arresting device 100 having an exemplary U-shaped end 506 in accordance with one aspect of the present application. Typically, the U-shaped end 506 of the leg arresting device 100 will have a width W1 able to fit the size of an armrest 106 of a seat 102. The U-shaped end 506 can include a fastening mechanism that secures the U-shaped end 506 to the armrest 106.

In another embodiment of the present application, the U-shaped end 506 includes a “cushion-like” cover on the inside of the “U-shape” itself. Generally, the cushion-like cover will be made of a material having a high coefficient of friction that prevents the leg arresting device 100 from moving up and down the armrest 106. Through the cushion like cover, a single leg arresting device 100 can be used among a number of different armrests 106. This is particularly useful as each manufacturer tends to have different armrest 106 widths W1. For example, a Boeing 757 typically has an armrest 106 that is five cm wide in the rear section, while the Airbus family has an armrest 106 having a width of about 45 mm.

In an alternative embodiment of the present application, the U-shaped end member 506 can be built without a cushion-like cover. This allows the leg arresting device 100 to “free-fall” from the front seat 102 armrest 106 once the user's knee is no longer resting on the leg arresting device 100 and into a storage position. In some instances, the free-fall of the leg arresting device 100 is desired. For instance, the free-fall feature is important when users must evacuate immediately. In such a case, the passengers will find no obstruction in their way while abandoning or leaving their seats 102.

Continuing with FIG. 7A, a diagram showing a top view of an exemplary foldable leg arresting device 100 having an illustrative U-shaped end 506 in accordance with one aspect of the present application is presented. In this embodiment, the leg arresting device 100 includes a pivoting hinge or ring 802 coupling the arm 504 and the leg engaging surface 502. Typically, the ring 802 allows for the leg engaging surface 502 to move along line R5 thereby collapsing the leg arresting device 100. This reduces the overall size of the leg arresting device 100. In an alternative embodiment, the ring 802 could allow the leg engaging surface 502 to release and swing around the other way along an arc complementary to arc R5 if enough force is applied to the leg engaging surface 502 to facilitate quick exit in case of emergency.

In FIG. 7B, a diagram showing a top view of an alternative exemplary foldable leg arresting device 100 having an illustrative U-shaped end 506 in accordance with one aspect of the present application is presented. While FIG. 7A illustrated a leg engaging surface 502 capable of moving left and right through the use of ring 802, FIG. 7B shows an alternative exemplary foldable leg arresting 100 capable of moving in an up and down motion. This embodiment couples the leg engaging surface 502 to the arm 504 through a hinge or ring 804. One skilled in the relevant art will appreciate that there are many ways to couple the pieces together and the movement among the pieces is not limited to an up and down or left and right motion, but can include other rotational motions. In addition, both embodiments described in FIGS. 7A and 7B can include a fastening device. The fastening device can hold the angle at which the leg engaging arm 504 is connected at.

FIG. 7C is a diagram showing a top view of an exemplary slidable leg arresting device 100 having an illustrative U-shaped end 506 in accordance with one aspect of the present application. In this embodiment, the leg engaging surface 502 can slide back and forth along line L1. The user can slide the pieces back and forth until the desired extension length is obtained. The leg engaging surface 502 can then be secured by a strap-like latch 806. The strap-like latch 806 can be a hook and loop fastener. Alternatively, the latch 806 can be a mechanical type latch. One skilled in the relevant art will appreciate that there are a number of ways to fasten the leg engaging surface 502 and the arm 504 of the leg arresting device 100 together.

In an illustrative method for using the leg arresting device 100, the user begins by retrieving the leg arresting device 100. The leg arresting device 100 can be retrieved from a compartment 104 located in front of the user or some other storage area. In turn, the user mounts the leg arresting device 100 in front of them. The leg arresting device 100 can be mounted to a front seat 102, wall 202, or some other attachment point described in this application.

The user then adjusts the leg engaging surface 502 of the leg arresting device 100 to brace the user's knee area by manipulating an arm 504 attached to the leg engaging surface 502. In most cases, the knee area corresponds to the lower part of the femur and the upper part of the user's tibia. This comfortably restrains the user's leg from entering into an aisle. After the user is finished with the leg arresting device 100, the leg arresting device 100 can be stored back into the compartment 104 or other storage area. In an alternative embodiment of the method, the user may use two leg arresting devices 100.

In an alternative method for preventing injuries in a common aisle of a common carrier, the user positions a leg arresting device 100 besides their knee or leg. The leg arresting device 100 includes a leg engaging surface 502, an arm 504 coupled to the surface 502, and an end member 506 coupled to the arm 504. The user adjusts at least one of the leg engaging surface 502, arm 504, and end member 506 of the leg arresting device 100 so that the leg engaging surface 502 comfortably braces the user's knee or leg. In this illustrative method, for example, the user can adjust the leg engaging surface 502 of the leg arresting device 100 by rotating or flipping the leg engaging surface 502 as described above. In addition, the arm 504 can be adjusted by bending it so that the user can comfortably engage the surface 506 with the user's leg or knee. Furthermore, the end member 506 can be adjusted based on the angle at which it is positioned at. While this illustrative method discloses a couple of the features for adjusting the leg engaging surface 502 so that it may be comfortably pressed against the user's knee or leg, numerous ways for adjusting the leg engaging surface 502, arm 504, and end member 506 have been presented herein.

Continuing, the method includes blocking the user's with the leg engaging surface 502 and thereby preventing the user's knee or leg from entering the common aisle when the user's knee or leg moves laterally enough to engage the leg engaging surface 502.

In yet another illustrative method, a method for restraining a user's knee or leg from entering into an aisle of a plane, train, or other common carrier using a leg arresting device 100 having a leg engaging surface 502, an arm 504 coupled to the leg engaging surface 502, and an end member 506 coupled to the arm 504 is presented. The method includes positioning the leg arresting device 100 on an aisle entry. The aisle entry typically occurs at the end of the rows of the common carrier. In one embodiment, the aisle entry is delineated by strips of metal or lighted plastic in an airplane or bus.

While the methods presented above were described in steps, one skilled in the relevant art will appreciate that the steps are for illustrative purpose only and should not be construed as limiting. In alternative embodiments, the steps taken in the method can be substituted using different steps or performed in a different order.

In addition, the method includes the user manipulating at least one of the leg engaging surface 502, arm 504, and end member 506 of the leg arresting device 100 to prevent lateral movement of the user's knee or leg pass the aisle entry and into the aisle.

The system for providing protection to passengers of a common carrier itself includes at least one or more seats 102. In one illustrative embodiment, the system includes an attachment point positioned in front of the at least one or more seats 102. In addition, the system includes a leg arresting device 100 coupled to the attachment point in front of the at least one or more seats 102. The leg arresting device 100 has a leg engaging surface 502, an arm 504 coupled to the leg engaging surface 502, and an end member 506 coupled to the arm 504.

Although the invention has been described with reference to one or more preferred embodiments, the description is not to be construed in a limiting sense. There is modification of the disclosed embodiments, as well as alternative embodiments of this invention, which will be apparent to persons of ordinary skill in the art and various changes in form and detail may be made therein without departing from the spirit and scope of the invention. The invention shall be viewed as limited only by reference to the following claims.

What is claimed is:

1. A method for preventing injuries in a common aisle of a common carrier comprising:
positioning a leg arresting device beside a user's knee or leg, the leg arresting device having a leg engaging surface, an arm, and an end member; and
adjusting at least one of the leg engaging surface, arm, and end member of the leg arresting device so that the leg engaging surface block the user's knee or leg from entering the common aisle when the user's knee or leg moves laterally enough to engage the leg engaging surface.

2. The method of claim 1, wherein the positioning step comprises extending the leg arresting device.

3. The method of claim 2, wherein extending the leg arresting device comprises rotating at least the leg engaging surface of the leg arresting device about a hinge.

4. The method of claim 3, wherein rotating the leg engaging surface of the leg arresting device comprises swinging the leg engaging surface up and down.

5. The method of claim 3, wherein rotating the leg engaging surface of the leg arresting device comprises swinging the leg engaging surface left and right.

6. The method of claim 2, wherein extending the leg arresting device comprises sliding the leg engaging surface away from the arm then securing the leg engaging surface in relation to the arm with a strap-like latch.

7. The method of claim 2, wherein extending the leg arresting device comprises unfolding the leg engaging surface from the arm.

8. A method for restraining a user's knee or leg from entering into an aisle of a plane, train, or other common carrier using a leg arresting device having a leg engaging surface, an arm coupled to the leg engaging surface, and an end member coupled to the arm comprising:
positioning the leg arresting device on an aisle entry;
manipulating at least one of the leg engaging surface, arm, and end member of the leg arresting device to prevent lateral movement of a the user's knee or leg pass the aisle entry and into the aisle.

9. The method of claim 8, wherein positioning the leg arresting device comprises swinging the leg arresting device left and right along a vertical axis.

10. The method of claim 9, wherein swinging the leg arresting device left and right further comprises preventing the leg arresting device from swinging into the aisle.

11. The method of claim 8, wherein the leg engaging surface is anatomically contoured so that it comfortably engages the knee or leg of the user.

12. The method of claim 8, further comprising removing pressure from the leg arresting device allowing the leg arresting device to free fall into a storage position.

13. The method of claim 8, further comprising resting or leaning the weight of the user's legs on or against the leg arresting device thereby relaxing the user's muscles allowing the user to sleep.

14. A system for providing protection to passengers of a common carrier, the system comprising:
one or more seats;
an attachment point positioned in front of each of the one or more seats;
a leg arresting device coupled to the attachment point and comprising a leg engaging surface, an arm, and an end member.

15. The system of claim 14, further comprising a compartment located in front of each of the one or more seats for storing the leg arresting device, the compartment defined by an elongated slot or indentation conformed to the shape of the leg engaging surface.

16. The system of claim 14, wherein the attachment point positioned in front of at least one of the one or more seats is a wall within the common carrier.

17. The system of claim 14, wherein the attachment point positioned in front of at least one of the one or more seats is another seat.

18. The system of claim 14, wherein the leg engaging surface is anatomically contoured so that it comfortably engages the knee or leg of the user.

19. The system of claim 14, wherein the end member is U-shaped and removably attached to an armrest of a seat.

20. The system of claim 19, wherein the U-shaped end member comprises a cushion-like cover for securing the leg arresting device to the armrest of the seat.

21. The system of claim 14, wherein the end member is a flat surface configured to be inserted into an attachment point, the attachment point being a slot.

22. The system of claim 14, wherein the user rests or leans their leg on or against the leg engaging surface thereby relaxing the user's muscles and allowing the user to sleep.
